(19) United States
(12) Patent Application Publication
(10) Pub. No.: US 2023/0131485 A1
(43) Pub. Date: Apr. 27, 2023

(54) METHOD AND DEVICE FOR DEPLOYING DEORBIT SAIL

(71) Applicant: SPACETY CO., LTD. (CHANGSHA), Changsha City, Hunan Province (CN)

(72) Inventors: Xiaoming LI, Changsha City, Hunan Province (CN); Zhanhui WANG, Changsha City, Hunan Province (CN); Yu ZOU, Changsha City, Hunan Province (CN); Weijia REN, Changsha City, Hunan Province (CN)

(21) Appl. No.: 17/045,338

(22) PCT Filed: Nov. 29, 2019
(86) PCT No.: PCT/CN2019/121955

§ 371 Date: Oct. 5, 2020

(30) Foreign Application Priority Data
Jul. 12, 2019 (CN) 201910633220.0

(51) Int. Cl. B64G 1/24; B64G 1/22

(52) U.S. Cl. CPC B64G 1/242; B64G 1/222

(57) ABSTRACT

A deorbit-sail deployment device for forming a deorbit sail that drives a satellite to deorbit is disclosed. The deorbit-sail deployment device comprises a non-folding sail and a folding sail that are rotatably connected to each other to form the deorbit sail The folding sail comprises at least one first skeleton that folds the sail body in the folded state and supports the sail body in the unfolded state. The folding sail can be folded to a compact size before launch.

### BACKGROUND OF THE INVENTION

### 1. Technical Field

The present invention relates to deorbit technology in the field of spacecraft, and more particularly to a deorbit-sail deployment device and a method for deploying a deorbit sail.

### 2. Description of Related Art

A deorbit sail is a passive deorbit solution working as a low-cost break sail device that makes a cubesat at the end of its service life leaves its original orbit rapidly to prevent the failed cubesat from becoming wandering space debris. A deorbit sail needs to satisfy the following requirements in addition to the general design principles and technical indicators for mechanical components:

(1) Lightweightness: a deployed deorbit sail also sees the change in its mass distribution. As more mass becomes far away from the principal axis of inertia, the requirements for attitude control are more demanding. Besides, since the launch cost for a satellite is highly dependent on its mass, it is desirable to make a deorbit sail as light in weight as possible without compromising its rigidity.

(2) Adaptability to Space: the space environment involves complicated conditions like high vacuity, alternating temperature, electron radiation, ultraviolet radiation, microgravity, space debris, and low-orbit atomic oxygen, which have to be taken into account when a deorbit sail is designed. For example, the surfaces of structures and mechanisms exposed in the space environment need to be protected from performance degradation, and moving components need to be protected from vacuum cold welding, while structures and mechanisms need to be protected from excessive deformation under temperature alteration.

(3) High Reliability: since repair and maintenance are almost impossible with a launched satellite, a deorbit sail used for a satellite needs to have high mechanical reliability.

For example, China Patent Publication No. CN105799956A discloses a cubesat drag sail de-orbit device, which is composed of two completely identical cubesat drag sail de-orbit sub-devices. Each cubesat drag sail de-orbit sub-device comprises a de-orbit device body and a partition board arranged on the top of the de-orbit device body, wherein the de-orbit device body is of a central symmetry structure and comprises a main frame, an upper end cover, a sail storage chamber guide rail, a Hall sensor, a base plate, and two expanding mechanisms. The main frame is Z-shaped and is divided into two identical chambers with the center of the main frame as the symmetry center. The two expanding mechanisms are arranged in the two chambers respectively. Four film sails are expanded in four directions by means of tape spring masts to increase the normal sectional area of satellite movement, so as to successfully solve the problem that a cubesat stays on the original track for a long time after fulfilling a task and becomes space debris. The disclosure of this patent is incorporated by reference herein in its entirety.

For example, China Patent Publication No. CN207292479U discloses a cubesat drag sail de-orbit device, including a locking device, a storing mechanism, an installation panel, a volute spring, a development mechanism, and a film sail. The locking device is fixed on the top surface of the installation panel. The storing mechanism is fixed on the bottom surface of the installation panel. The volute spring, the development mechanism, and the film sail are arranged in the storing mechanism. The volute spring has its large-diameter end connected with the installation panel, and the small-diameter end connected with the development mechanism. The film sail is tied up on the development mechanism and has its top fixed to the bottom of the satellite bottom by means of a top installation panel, so as to be not take up space inside the satellite. After the instruction from the ground is received, the locking device releases the central shaft in the development mechanism, so that the strip-like resilient mast wound around the central shaft discharges elastic potential energy it stores and thus allows the film fixed on the mast to be unfolded. The prior-art device increases the sectional area of the cubesat in its travel direction by unfolding the film sail, thereby increasing the atmospheric drag suffered by the cubesat and facilitating rapid leave from the orbit of the cubesat. The disclosure of this patent is incorporated by reference herein in its entirety.

ZENG Yutang has referred to a deorbit device in his master's thesis titled “Design and Research of Cubesat Drag Sail De-Orbit Device.” This known device is composed of a drag sail cabin, a boom deploying mechanism and a shaft locking mechanism. The boom deploying mechanism provides driving force to deploy the boom by means of the resilient strain energy stored by the boom. The shaft locking mechanism functions as a switch of the drag sail device by suppressing rotation of the central shaft within the boom deploying mechanism.

Based on the understanding of the prior art, the existing deorbit devices at least have the following shortcomings: these devices are designed to be partially or entirely installed inside the satellite and thus disadvantageously complicate the internal structure of the satellite.

In view that discrepancy may exist between the prior art comprehended by the applicant of this patent application and that known by the patent examiners and since there are many details and disclosures disclosed in literatures and patent documents that have been referred by the applicant during creation of the present invention not exhaustively recited here, it is to be noted that the present invention shall actually include technical features of all of these prior-art works, and the applicant reserves the right to supplement the application with the related art more existing technical features as support according to relevant regulations.

### SUMMARY OF THE INVENTION

To address the shortcomings of the prior art, the present invention provides a deorbit-sail deployment device, comprising a non-folding sail and a folding sail that are rotatably connected to each other to form the deorbit sail for forming a deorbit sail that drives a satellite to deorbit.

The folding sail including a sail body and skeletons that fold a sail body in a folded state and support the sail body in an unfolded state, the skeletons are used to fold the folding sail body and when the folding sail body is folded, the skeletons are fixed on the non-folding sail, which can keep the folding sail outside of the satellite and is beneficial for the folding sail to be directly unfolded outside the satellite when receiving the instruction from the ground, instead of ejecting from the satellite and then unfolding, thus it effectively saves the space in the satellite.

When the folding sail is partially free from the constraint of the non-folding sail, at least one of the skeletons is allowed to rotate about the non-folding sail in a manner that the skeleton is fixed to the folding sail. In this way, when the skeletons fixed on the folding sail rotates around the non-folding sail, the rest of the skeletons on the folding sail also has a constraining relationship with the non-folding sail, which helps to prevent the restraint force from being released too fast when the constraint of the folding sail is released leading to a high development speed of the folding sail body, thereby effectively avoiding damage to the folding sail body. Secondly, the skeletons fixed to the folding sail always keep synchronization with the folding sail when rotating around the non-folding sail, so that the skeletons can be used as the inertial main axis of the folding sail. Therefore, the skeletons can be used as the symmetrical main axis of the folding sail when the folding sail is fully deployed to provide support for the unfolded folding sail.

The rest of the skeletons are allowed to rotate with respect to the non-folding sail in a manner that the skeletons rotate about the folding sail. In this way, the rest of the skeletons can unfold the sail body by simultaneously winding the folding sail and the non-folding sail after the folding sail fully unconstrained from the non-folding sail. On the one hand, this helps the unfolded folding sail body to have a larger surface-to-mass ratio (large area and small mass); on the other hand, during the unfolding process of the rest of the skeletons, the rest of the skeletons can maintain the sail body of the folded sail unfolded symmetrically, so that during the unfolding process, the folding sail body forms a symmetrical windward surface with the skeletons fixed to the folding sail as the axis of symmetry, which ensures that the folding sail can be deployed steadily while preventing irregular movement of the satellite.

Preferably, the folding sail comprises at least one first skeleton that folds the sail body in the folded state and supports the sail body in the unfolded state, when a first included angle formed between the folding sail and the non-folding sail in a process that the folding sail rotating with respect to a first side of the non-folding sail comes to a first threshold value, one or more of the first skeletons are allowed to rotate about the folding sail in a manner that the first skeletons remain parallel to the first side, and the folding sail continues to rotate with respect to the first side of the non-folding sail, so that the first included angle continuously increases a second threshold value that allows the folding sail and the non-folding sail to form the deorbit-sail.

Advantageously, the folding sail includes at least one second skeleton that folds the sail body in the folded state and supports the sail body in the unfolded state, in which at least one part of the second skeleton is folded into the first skeleton when receiving a contact force between the part and the non-folding sail in a manner that the part is allowed to rotate about the first skeleton, so that in the process that the folding sail rotates with respect to the first side of the non-folding sail the second skeleton is allowed to rotate about the first skeleton in a manner that a deployed area of the deployed deorbit sail is allowed to increase.

Advantageously, during unfolding of the folding sail the folding sail rotates at a speed greater than or equal to a speed at which the first skeleton rotates; and/or the folding sail rotates at a speed greater than or equal to a speed at which the second skeleton rotates.

Advantageously, the folding sail includes a first skeleton II and at least two first skeletons I that are evenly distributed at two sides of the first skeleton II, in which the first skeleton II never rotates about the folding sail, and the at least two first skeletons I rotate about the folding sail at a same speed when the first included angle between the folding sail and the non-folding sail is greater than the first threshold value, so that the first skeleton II and the first skeletons I are allowed to form a support structure that supports the sail body during travel of the satellite and during unfolding of the folding sail.

Advantageously, the non-folding sail has a first sail surface that is provided with a fastening hole configured to be engaged with a fastening member provided on the first skeleton, in which when the first included angle formed between the folding sail and the non-folding sail in the process that the folding sail rotates with respect to the first side of the non-folding sail is smaller than the first threshold value, the fastening member and the fastening hole interact to prevent the first skeleton from rotating about the folding sail.

Advantageously, when the folding sail is in the folded state, a second sail surface of the folded folding sail in the folding state and the first sail surface in the folding state are opposite to each other; when the folding sail is in the fully unfolded state, the second sail surface in the fully unfolded state and the first sail surface jointly form a windward surface or a leeward surface.

Advantageously, the folding sail during unfolding has at least intermediate attitudes of: when the first included angle is smaller than the first threshold value, a second included angle between the first skeleton I and a second side of the non-folding sail being 0°; or when the first included angle is greater than the first threshold value and smaller than the second threshold value, the second included angle increases with the first included angle in a manner that a maximum of the second included angle being smaller than 90°; and when the first included angle is equal to the second threshold value, the second included angle being equal to 90°; wherein in a process that the second included angle increases with the first included angle, a free end of a said second skeleton II in the first skeleton II is allowed to rotate about the first skeleton II without coming into contact with the non-folding sail.

Advantageously, a holding mechanism is provided between the non-folding sail and the folding sail, and serves to hold the folding sail in the folded state during travel of the satellite, wherein the holding mechanism installed between the non-folding sail and the folding sail is configured to automatically release fixation between the non-folding sail and the folding sail in response to a deorbit instruction, so that the folding sail is allowed to rotate about the first side of the non-folding sail.

Advantageously, the present invention further discloses a folding sail for deployment of a deorbit sail, being configured to be unfolded in a process that it rotates about a non-folding sail connected to a satellite and to form the deorbit sail with the non-folding sail to form the deorbit sail, the folding sail being characterized in: the folding sail including a sail body and skeletons that fold the sail body into a folded state and unfold the sail body into an unfolded state, at least one of the skeletons is allowed to rotate about the non-folding sail in a manner that it is fixed to the folding sail when the folding sail is partially free from the constraint of the non-folding sail, and the rest of the skeletons are allowed to rotate with respect to the non-folding sail in a manner that the skeletons rotate about the folding sail.

Advantageously, the method is realized by the aforementioned deployment device or the aforementioned folding sail.

The present invention further provides a deorbit sail, comprising a non-folding sail and a folding sail that are rotatably connected to each other to form the deorbit sail for driving a satellite equipped with the deorbit sail to deorbit; wherein the folding sail including a sail body and at least one first skeleton as well as at least one second skeleton that fold the sail body into a folded state and unfold the sail body into an unfolded state. At least one part of the second skeleton is folded into the first skeleton when receiving a contact force between the part and the non-folding sail in a manner that the part is allowed to rotate about the first skeleton, so that in a process that the folding sail rotates with respect to a first side of the non-folding sail the second skeleton is allowed to rotate about the first skeleton in a manner that a deployed area of the deployed deorbit sail is allowed to increase.

As compared to the prior art, the device and method for deployment of a deorbit sail as disclosed in the present invention have at least the following advantages:

1) The disclosed deorbit sail can be arranged outside a satellite without taking up space inside the satellite. The folding sail can be folded to a compact size before launch. After the satellite completes its task, the folding sail can be well unfolded and held in the unfolded state. The deployed frame shall have sufficient strength and rigidity, so as to ensure its support ability without compromising its attitude control. The deorbit sail when in its deployed state has an area-to-mass ratio that is high enough.

2) The folding sail is not unfolded until it works with the non-folding sail to form the first included angle α. This prevents a sudden change in external load that hampers travel of the satellite.

3) In the space environment, as the first skeleton rotates, the folding sail continues to rotate in a manner that the first included angle α increases, so as to ensure synchronous and simultaneous expansion of the deorbit sail and prevent the sail body from sudden failure.

### BRIEF DESCRIPTION OF THE DRAWINGS

FIG. 1 is a schematic drawing of a deorbit-sail device in its folded state according to the present invention, showing a second skeleton 300b affected by a contact force between a second skeleton 300b and a non-folding sail 200;

FIG. 2 is a schematic drawing of the deorbit-sail device in its intermediate deployed state according to the present invention, showing the first skeleton I 300a-1 rotating about a folding sail 300 in a manner that the first skeleton I 300a-1 and a second side of the non-folding sail 200 form a second included angle β;

FIG. 3 is a schematic drawing of the deorbit-sail device in its fully deployed state according to the present invention, showing the folding sail in its deployed state with β being 90°;

FIG. 4 is a schematic drawing of the deorbit-sail device in its another intermediate deployed state according to the present invention, showing a deployed state of the folding sail when a first included angle α is smaller than a first threshold value; and

FIG. 5 shows the relative position of the deorbit sail in its fully deployed state according to the present invention.

100: satellite; 200: non-folding sail; 300: folding sail; 400: connecting board; 200a: first sail surface; 200b: fastening hole; 300a: first skeleton; 300b: second skeleton; 300c: second sail surface; 300d: f fastening member; 300a-1: first skeletons I; 300a-2: first skeleton II; 300b-1: second skeleton I; 300b-2: second skeleton II; 400a: hinge; α: first included angle; β: second included angle; γ: third included angle.

### DETAILED DESCRIPTION OF THE INVENTION

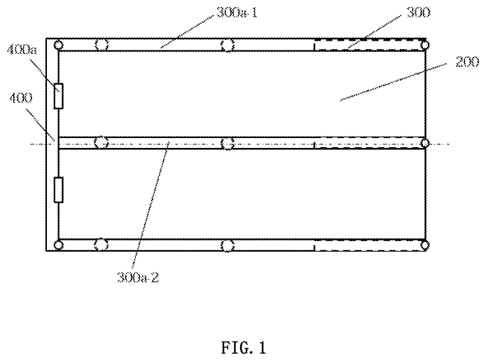

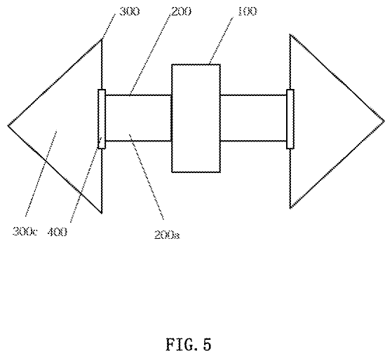

The following description is made with reference to the accompanying drawing FIGS. 1-5.

According to one feasible mode, the present invention discloses a deorbit-sail deployment device.

As shown in FIGS. 1-5, the deorbit-sail deployment device comprises a non-folding sail 200 and a folding sail 300. The non-folding sail 200 and the folding sail 300 are rotatably connected to jointly drive the satellite 100 to deorbit. Preferably, the non-folding sail 200 has a first side provided with a connecting board 400. The connecting board 400 is provided with a hinge 400a that enables the folding sail 300 to rotate with respect to the first side.

The folding sail 300 includes including at least one first skeleton 300a that folds the sail body in a folded state and supports the sail body in an unfolded state. Preferably, the first skeleton 300a is made of, for example, a lightweight alloy steel. Use of lightweight alloy steel allows the folding sail 300 to have desirable mechanical rigidity and strength that satisfy technical indicators while being light in weight.

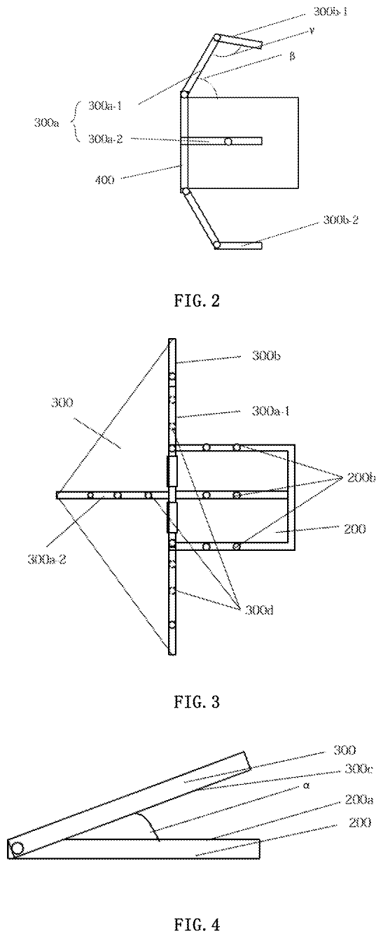

The folding sail 300 is configured to rotate with respect to the first side of the non-folding sail 200. The folding sail 300 and the non-folding sail 200 include a first included angle α. When the first included angle α reaches a first threshold value, at least one or more of the first skeletons 300a start to rotate about the folding sail 300 in a manner that they are parallel to the first side. For example, as shown in FIG. 2, the first skeletons I 300a-1 at the two sides of the folding sail 300 can rotate about the folding sail 300 in a manner that they work with the second side of the non-folding sail 200 to form the second included angle β, until β is equal to 90° (as shown in FIG. 3). Preferably, as shown in FIG. 2, the first side and the second side are perpendicular to each other. That is, the non-folding sail 200 at least have two mutually perpendicular sides, meaning that the non-folding sail 200 is rectangular or square, for example. At this time, the folding sail 300 continues to rotate with respect to the first side of the non-folding sail 200, and the first included angle α continues to increase. When the first included angle α increases and comes to a second threshold value, the folding sail 300 and the non-folding sail 200 form the deorbit sail, as shown in FIG. 3. As compared to the prior art, the disclosed deorbit sail configured as described above has at least the following advantages: 1. The disclosed deorbit sail can be arranged outside the satellite 100 without taking up space inside the satellite 100; 2. The folding sail 300 is not unfolded until it works with the non-folding sail 200 to form a certain angle (i.e. the first included angle α), thereby preventing sudden changes in external load that hampers travel of the satellite; and 3. In the space environment, as the first skeleton 300a rotates, the folding sail 300 continues to rotate in a manner that the first included angle α increases, so as to ensure synchronous and simultaneous expansion of the deorbit sail and prevent the sail body from sudden failure.

The first included angle α may have the meaning used in geometry and thus be understood as a dihedral angle between the folding sail 300 and the non-folding sail 200. In other words, the first included angle α may be a dihedral angle between the first sail surface 200a and the second sail surface 300c. When the first included angle α is 0, the first sail surface 200a and the second sail surface 300c are opposite to each other. When the first included angle α is of 180 degrees, the first sail surface 200a and the second sail surface 300c jointly form a windward surface or a leeward surface. The first threshold value is preferably of 3-10°. The first threshold value is in particular preferably of 4-7°. The second threshold value is preferably of 180°. The first threshold value is related to the location and size of the fastening member.

Preferably, the folding sail 300 includes at least one second skeleton 300b. The second skeleton 300b is identical or similar to the first skeleton 300a in terms of function, namely folding the sail body into the folded state and supporting the sail body in the unfolded state. As shown in FIG. 1, with the contact force between the second skeleton 300b and the non-folding sail 200, at least one part of the second skeleton 300b is folded into the first skeleton 300a. As the folding sail 300 rotates with respect to the first side of the non-folding sail 200, the second skeleton 300b rotates about the first skeleton 300. With such a configuration, the present invention further has at least the following advantages: 1. The second skeleton 300b when folded in the first skeleton 300a makes the sail body compact enough to be installed in a narrow space and when deployed provides an unfolded area that is large enough; 2. As the folding sail 300 rotates, the second skeleton 300b due to its connection with the first skeleton 300a and based on its contact with the non-folding sail 200 can gradually separate from the non-folding sail 200, thereby autonomously rotating about the first skeleton 300a, which is favorable to weight reduction for the deorbit sail; and 3. The deorbit sail in its deployed state has an area-to-mass ratio that is high enough, meaning that it is low in mass yet large in area.

Preferably, during the unfolding of the folding sail 300, the folding sail 300 rotates at a speed greater than or equal to a speed at which the first skeleton 300a rotates. In this way, the rotation speed of the folding sail 300 is greater than or equal to the rotation speed of the second skeleton 300b. For example, the rotation speed of the first skeleton 300a and/or the rotation speed of the second skeleton 300b may be determined by rigidity of a torsion spring, so as to ensure that the rotation speed of the folding sail 300 is greater than or equal to the rotation speed of the first skeleton 300a and/or the rotation speed of the folding sail 300 is greater than or equal to the rotation speed of the second skeleton 300b. In this way, the present invention at least has the following advantage: the sail body of the folding sail is configured to expand smoothly and stably.

Preferably, the folding sail 300 includes a first skeleton II 300a-2 and at least two first skeletons I 300a-1 evenly distributed at two sides of the first skeleton II 300a-2. The first skeleton II 300a-2 never rotates about the folding sail 300. When the first included angle α between the folding sail 300 and the non-folding sail 200 is greater than the first threshold value, the at least two first skeletons I 300a-1 rotate about the folding sail 300 at the same speed. Therefore, during deorbit travel of the satellite 100 and in the process that the folding sail 300 is unfolded, the first skeleton II 300a-2 and the first skeletons I 300a-1 can form a support structure that supports the sail body. With such a configuration, the present invention further has at least the following advantages: 1. During the deployment of the deorbit sail, in virtue of its structural symmetry, the deorbit sail remains its mass distribution and in turn its principal axis of inertia (the first skeleton II 300a-2) unchanged. This helps to minimize interference with the flying attitude of the satellite 100, so as to achieve accurate deorbit flying attitude. As shown in FIGS. 1-3, the folding sail 300 includes a first skeleton II 300a-2 and two first skeletons I 300a-1 that are symmetrically centered about the first skeleton II 300a-2.

Preferably, the non-folding sail 200 has its first sail surface 200a provided with a fastening hole 200b that is configured to engage with a fastening member 300d provided on the first skeleton 300a. When the folding sail 300 rotates with respect to the first side of the non-folding sail 200 to an extent that the first included angle α between the folding sail 300 and the non-folding sail 200 is smaller than the first threshold value, the fastening member 300d and the fastening hole 200b interact to prevent the first skeletons 300a from rotating about the folding sail 300. The engagement between the fastening member 300d and the fastening hole 200b may be realized by means of sliding friction therebetween. That is, when the folding sail 300 is opposite to the first side of the non-folding sail 200, sliding friction occurs between the fastening member 300d and the fastening hole 200b, so that the folding sail 300 and the non-folding sail 200 include the first included angle α.

Preferably, when the folding sail 300 is in the folded state, the second sail surface 300c of the folded folding sail 300 and the first sail surface 200a are opposite to each other. When the folding sail 300 is fully unfolded, the second sail surface 300c in the fully unfolded state and the first sail surface 200a jointly form a windward surface or a leeward surface.

Preferably, during its deployment, the folding sail 300 at least has the following intermediate attitudes, namely a first attitude, a second attitude, and a third attitude. The first attitude, as shown in FIG. 4, exists when the first included angle α is smaller than the first threshold value. At this time, the second included angle β included between the first skeleton I 300a-1 and the second side of the non-folding sail 200 is of 0 degree. The second attitude, as shown in FIG. 2, exists when the first included angle α is greater than the first threshold value and smaller than the second threshold value. At this time, the second included angle β increase with the first included angle α in a manner that its maximum is smaller than 90°. The third attitude, as shown in FIG. 3, exists when the first included angle α is equal to the second threshold value. At this time, the second included angle β is equal to 90°.

Preferably, as the second included angle β increases with the first included angle α, the free end of the second skeleton II 300b-2 in the first skeleton II 300a-2 is allowed to rotate about the first skeleton II 300a-2 without coming into contact with the non-folding sail 200. The free end of the second skeleton II 300b-2 refers to an end opposite to the end of the second skeleton II 300b-2 connected to the second skeleton II 300b-2. In the present invention, the second skeleton II 300b-2 may be expanded as described below. When t the first included angle α is greater than a third critical angle and the second included angle is greater than a fourth critical angle, the second skeleton II 300b-2 starts to rotates about the first skeleton II 300a-2. The third critical angle is greater than the first critical angle and smaller than the second critical angle. The space angle formed by the third critical angle and the fourth critical angle can exactly prevent the second skeleton II 300b-2 from touching the non-folding sail 200. For example, a press plate is installed on the second skeleton I 300b-1 and configured to engage with a fit hole formed on the second skeleton II 300b-2. When the second skeleton I 300b-1 is fixed, the press plate follows it to rotate, and thus can release the fit hole from the press plate when the first included angle α becomes greater than the third critical angle and the second included angle becomes greater than the fourth critical angle, so as to allow the second skeleton II 300b-2 to rotate about the first skeleton II 300a-2. With such a configuration, the present invention further has at least the following advantages: 1. When expanded, the second skeleton II 300b-2 is prevented from damaging the non-folding sail 200; and 2. During deployment, the overall mass distribution of the deorbit sail is kept uniform.

Preferably, a holding mechanism is arranged between the non-folding sail 200 and the folding sail 300. The holding mechanism serves to hold the folding sail 300 in the folded state during the travel of the satellite 100. The holding mechanism when receiving a deorbit instruction can automatically release the fixation between the non-folding sail 200 and the folding sail 300, so as to allow the folding sail 300 to start to rotate about the first side of the non-folding sail 200. The deorbit instruction may come from a ground control center and be transmitted to execution equipment of the holding mechanism through communication equipment. The execution equipment then unlocks the holding mechanism, so as to release the folding sail 300. For example, the holding mechanism includes a connecting wire and a fuse resistor. The connecting wire has its one end fixed to the fuse resistor until the holding mechanism receives the deorbit instruction. The connecting wire has its opposite end fixed to the folding sail 300. The fuse resistor is fixed to the non-folding sail 200 by means of screws. The fuse resistor, when powered, generates heat to fuse the connecting wire, thereby freeing the folding sail 300 from said fixation and allowing it to rotate. The fuse resistor has its resistance preferably of 5-20 ohms, and more preferably of 10 ohms. Preferably, the connecting wire may be a fishing line. After the holding mechanism receives the deorbit instruction, the fuse resistor is powered to heat and fuse the fishing line, thereby releasing the fixation between the non-folding sail 200 and the folding sail 300. Preferably, the fuse resistor may be a power resistor, which generates heat when powered and transfers the heat to the fusible line for fusing the latter. Preferably, the fusible line may be a fishing line. Preferably, the fuse resistor is powered as described below. A microprocessor in the satellite 100 when receiving a deorbit instruction from the ground issues a closure instruction to a magnetic switch connected in series with the fuse resistor. The magnetic switch closes to generate a current I. Preferably, the fuse resistor is powered by a power supply in the satellite 100. Having the satellite equipped with the power supply is known in the art. Communication with the satellite through ground instructions is known in the art. Communication between the microprocessor and the magnetic switch is also known in the art. Hence, using a fuse resistor to fuse a fusible line can be easily realized by people skilled in the art by using common knowledge.

According to one feasible mode, the present invention discloses a folding sail 300 that is at least applicable to the foregoing deorbit-sail deployment device. The folding sail includes at least one first skeleton 300a and a sail body. Preferably, it may further include a second skeleton 300b. The sail body may be an aluminum foil sail, which is sewn onto the skeletons with cotton thread. The sail body may be a separate sail, or may be plural pieces pieced together between each two said first skeletons 300a. When the folding sail 300 is folded, the sail body is set in a folded state by the first skeleton 300a and the second skeleton 300b. When the folding sail 300 is unfolded, the sail body is supported by the first skeleton 300a and the second skeleton 300b and stays in the unfolded state.

As shown in FIGS. 1-3, the folding sail 300 includes two first skeletons I 300a-1 and one first skeleton II 300a-2. The two first skeletons I 300a-1 are symmetrically arranged at two sides of the first skeleton II 300a-2. The two first skeletons I 300a-1 and the one first skeleton II 300a-2 are all connected to the second skeleton 300b through torsion springs, so that the second skeletons 300b can rotate about the two first skeletons I 300a-1 and the first skeleton II 300a-2, respectively. The two first skeletons I 300a-1 are also connected to a connecting board 400 through a torsion spring, so that the two first skeletons I 300a-1 can both rotate about the folding sail 300.

In the present invention, the folding sail 300 can be unfolded while rotating about the non-folding sail 200 connected to the satellite 100 and to form the deorbit sail with the non-folding sail 200 to jointly form the deorbit sail. In the process that the non-folding sail 200 forms the deorbit sail, it remains stationary with respect to the satellite 100.

The first skeletons 300a fold the sail body into a folded state and support the sail body in an unfolded state. For differentiating different first skeletons 300a, the first skeletons 300a are herein divided into a first skeleton I 300a-1 and a first skeleton II 300a-2 by their movements and functions. As shown in FIGS. 2 and 3, while the folding sail 300 rotates, the first skeleton I 300a-1 also rotates about the folding sail 300 to form a part of a base of the unfolded folding sail 300. The first skeleton II 300a-2 have no movement with respect to the folding sail throughout the process that the folding sail 300 rotates, so as to form a height of the unfolded folding sail 300.

When the folding sail 300 rotates with respect to the first side of the non-folding sail 200 to the extent that the first included angle α between the folding sail 300 and the non-folding sail 200 is of the first threshold value, the first skeleton I 300a-1 starts to rotate about the folding sail 300 in a manner that it remains parallel to the first side, and the folding sail 300 continues to rotate with respect to the first side of the non-folding sail 200, so that the first included angle α continuously increases until it comes to a second threshold value where the folding sail 300 and the on-folding sail 200 form the deorbit sail. Throughout this process, the first skeleton II 300a-2 has no movement with respect to the folding sail 300.

According to one feasible mode, as shown in FIGS. 1-5, the deorbit-sail deployment device includes a non-folding sail 200 and a folding sail 300. The non-folding sail 200 and the folding sail 300 are connected through a connecting board 400. The connecting board 400 is provided with a hinge 400a, which enables the folding sail 300 to rotate about the non-folding sail 200. The non-folding sail 200 has an end opposite to the end having the connecting board 400 provided with a holding mechanism. For example, the holding mechanism includes a connecting wire and a fuse resistor. The connecting wire has its one end fixed to the fuse resistor until the holding mechanism receives the deorbit instruction. The connecting wire has its opposite end fixed to the folding sail 300. The fuse resistor is fixed to the non-folding sail 200 by means of screws. The fuse resistor, when powered, generates heat to fuse the connecting wire, thereby freeing the folding sail 300 from said fixation and allowing it to rotate. The fuse resistor has its resistance preferably of 5-20 ohms, and more preferably of 10 ohms. Preferably, the connecting wire may be a fishing line. Preferably, the fusible line may be a fishing line. Preferably, the fuse resistor is powered as described below. A microprocessor in the satellite 100 when receiving a deorbit instruction from the ground issues a closure instruction to a magnetic switch connected in series with the fuse resistor. The magnetic switch closes to generate a current I. Preferably, the fuse resistor is powered by a power supply in the satellite 100. Having the satellite equipped with the power supply is known in the art. Communication with the satellite through ground instructions is known in the art. Communication between the microprocessor and the magnetic switch is also known in the art. Hence, using a fuse resistor to fuse a fusible line can be easily realized by people skilled in the art by using common knowledge.

As shown in FIGS. 2-3, the folding sail 300 includes two first skeletons I 300a-1 and one first skeleton II 300a-2. The two first skeletons I 300a-1 are symmetrically arranged at two sides of the first skeleton II 300a-2, respectively. The two first skeletons I 300a-1 and the first skeleton II 300a-2 are all connected to the second skeletons 300b by means of torsion springs, so that the second skeletons 300b are allowed to rotate about the corresponding two first skeletons I 300a-1 and one first skeleton II 300a-2. The two first skeletons I 300a-1 are also connected to the connecting board 400 by means of torsion springs, so that the two first skeletons I 300a-1 can both rotate about the folding sail 300.

Preferably, each of the first skeletons 300a (i.e. the two first skeletons I 300a-1 and the first skeleton II 300a-2) has its side facing the first sail surface 200a provided with a fastening member 300d. The fastening member 300d is cylindrical. The first sail surface 200a is formed with a fastening hole 200b for engaging with the fastening member 300d. When the first sail surface 200a and the second sail surface 300c are opposite to each other, the fastening member 300d and the fastening hole 200b engage with each other.

Preferably, in the present invention, the first threshold value for the first included angle α is 6°. When a is smaller than 6°, the fastening member 300d and the fastening hole 200b are in sliding contact, and the two first skeletons I 300a-1 do not rotate about the folding sail 300. When a is equal to 6°, the fastening member 300d and the fastening hole 200b just separate. Therefore, when a is greater than or equal to 6°, the two first skeletons I 300a-1 rotate about the folding sail 300 in virtue of the torsion springs. Preferably, the second threshold value for the first included angle α is 180°. In other words, the folding sail 300 and the non-folding sail 200 form the deorbit sail in a manner that they are coplanar.

FIG. 2 shows an intermediate state of the deorbit device that is being deployed. The hinge 400a of the connecting board 400 drives the folding sail 300 to rotate about the non-folding sail 200. The projection of the first skeleton II 300a-2 of the folding sail 300 on the non-folding sail 200 is smaller than its actual length, which means that the first included angle α is formed between the folding sail 300 and the non-folding sail 200. The second skeleton II 300a-1 of the folding sail 300 rotates about the folding sail 300, and works with the second side of the non-folding sail 200 to form the second included angle β. The second included angle β is of 0-90°. The relationship between the second included angle β and the first included angle is as below. When the first included angle α is smaller than the first threshold value, β is 0 degree, meaning that the two first skeletons I 300a-1 do not rotate about the folding sail 300. When the first included angle α is equal to the first threshold value, β is close to 0 degree. The two first skeletons I 300a-1 start to rotate about the folding sail 300. As shown in FIG. 2, when the first included angle α s equal to the second threshold value, the second included angle β is equal to 90°. At this time, the two first skeletons I 300a-1 are parallel to the first side that has the connecting board, and the folding sail 300 is fully unfolded to form the deorbit sail with the non-folding sail 200 to form the deorbit sail.

Preferably, the fully deployed deorbit sail is in the shape of an isosceles triangle. The first skeleton II 300a-2 and the second skeleton 300b thereon jointly form the height of the isosceles triangle. Having the fully unfolded folding sail 300 being a triangular structure is at least favorable to stable form of the deorbit sail against air drag.

According to one feasible mode, the present invention provides a deployment method as described below:

First, when the first included angle α is smaller than the first threshold value, the folding sail 300 rotates about the first side of the non-folding sail 200, while the fastening member 300d on the first skeleton I 300a-1 and the fastening hole 200b on the non-folding sail 200 performs sliding friction;

Second, when the folding sail 300 rotates about the non-folding sail 200 to the extent that the first included angle α is equal to the first threshold value, the fastening member 300d of the first skeleton I 300a-1 completely departs from fastening hole 200b on the non-folding sail 200, so that the first skeleton I 300a-1 rotates about the folding sail 300 in virtue of the torsion spring connected thereto, and works with the second side of the non-folding sail 200 to form the second included angle β; and

Third, the second skeletons 300b on the first skeletons 300a in the process that the folding sail 300 rotates about the non-folding sail 200 can automatically depart from the non-folding sail 200, and can then rotate about the first skeleton 300 in virtue of their respective torsion springs. The first skeletons 300a and their respective second skeletons 300b form a third included angle γ in a certain period during unfolding of the folding sail 300. The third included angle γ is up to 180°. In other words, when the folding sail 300 is unfolded completely, the first skeleton 300a and the second skeleton 300b become collinear.

The deployment method has the following advantages. The deorbit sail is arranged outside a satellite without taking up space inside the satellite. Opposite to this, a traditional deorbit sail has to be installed in a satellite. Such an arrangement not only takes up space inside a satellite but also adds difficulty in the deployment of the deorbit sail. In the present invention, the folding sail 200 is stacked on the non-folding sail 300. Before launch, the folding sail is stacked on the non-folding sail to compact the deorbit sail. After the satellite finishes its task, the deorbit sail is smoothly deployed and stays in the deployed state. The expanded frame shall have adequate strength and rigidity so as to ensure good support while not interfering with attitude control. The deorbit sail when deployed has an area-to-mass ratio that is high enough.

According to one feasible mode, the present invention discloses a deorbit sail, which includes a non-folding sail 200 and a folding sail 300. The non-folding sail 200 and the folding sail 300 are rotatably connected to jointly drive a satellite 100 equipped with the deorbit sail to deorbit. The folding sail 300 includes skeletons that fold the sail body into a folded state and support the sail body in an unfolded state. At least one of the skeletons is allowed to rotate about the non-folding sail 200 in a manner that it is fixed to the folding sail 300, and the rest of the skeletons are allowed to rotate with respect to the non-folding sail 200 in a manner that the skeletons rotate about the folding sail 300.

Preferably, folding sail 300 includes at least one first skeleton 300a that folds the sail body into a folded state and supports the sail body in an unfolded state. When the folding sail 300 rotates with respect to the first side of the non-folding sail 200 to the extent that the first included angle α between the folding sail 300 and the non-folding sail 200 is of the first threshold value, one or more of the first skeletons 300a start to rotate about the folding sail 300 in a manner that they are parallel to the first side, and the folding sail 300 continues to rotate with respect to the first side of the non-folding sail 200, so that the first included angle α continuously increases until it comes to a second threshold value where the folding sail 300 and the on-folding sail 200 form the deorbit sail.

Preferably, the folding sail 300 includes at least one second skeleton 300b that folds the sail body into a folded state and supports the sail body in an unfolded state. At least one part of the second skeleton 300b, in virtue of the contact force between it and the non-folding sail 200, is folded in the first skeleton 300a in a manner that it is allowed to rotate about the first skeleton 300, so that in the process that the folding sail 300 rotates with respect to the first side of the non-folding sail 200, the second skeleton 300b rotates about the first skeleton 300a in a manner that the unfolded area of the deployed deorbit sail increases.

Preferably, during unfolding of the folding sail 300, the rotation speed of the folding sail 300 is greater than or equal to the rotation speed of the first skeleton 300a.

Preferably, during unfolding of the folding sail 300, the rotation speed of the folding sail 300 is greater than or equal to the rotation speed of the second skeleton 300b.

Preferably, the folding sail 300 includes a first skeleton II 300a-2 and at least two first skeleton I 300a-1 evenly distributed at two sides of the first skeleton II 300a-2. Therein, the first skeleton II 300a-2 never rotates about the folding sail 300, and the at least two first skeletons I 300a-1 when the first included angle α between the folding sail 300 and the non-folding sail 200 is greater than the first threshold value rotate about the folding sail 300 at the same speed, so that the first skeleton II 300a-2 and the first skeletons I 300a-1 form a support structure that supports the sail body during travel of the satellite 100 and during unfolding of the folding sail 300.

Preferably, the first sail surface 200a of the non-folding sail 200 is formed with fastening holes 200b configured to engage with fastening members 300d on the first skeleton 300a. When the folding sail 300 rotates with respect to the first side of the non-folding sail 200 to the extent that the first included angle α between the folding sail 300 and the non-folding sail 200 is smaller than the first threshold value, the fastening member 300d and the fastening hole 200b interacts, so as to prevent the first skeleton 300a form rotating about the folding sail 300.

Preferably, when the folding sail 300 is in the folded state, the second sail surface 300c of the folded folding sail 300 in the folding state and the first sail surface 200a are opposite to each other.

Preferably, when the non-folding sail 200 is fully unfolded, the second sail surface 300c in the fully unfolded state and the first sail surface 200a jointly form a windward surface or a leeward surface.

Preferably, during its deployment, the folding sail 300 at least has the following intermediate attitudes:

When the first included angle α is smaller than the first threshold value, the second included angle β formed between the first skeleton I 300a-1 and the second side of the non-folding sail 200 is 0°; or

When the first included angle α is greater than the first threshold value and smaller than the second threshold value, the second included angle β increases with the first included angle α in a manner that its maximum is smaller than 90°;

When the first included angle α is equal to the second threshold value, the second included angle β is equal to 90°.

Preferably, in the process that the second included angle β increases with the first included angle α, the free end of the second skeleton II 300b-2 in the first skeleton II 300a-2 can rotate about the first skeleton II 300a-2 without coming into contact with the non-folding sail 200.

Preferably, a holding mechanism is provided between the non-folding sail 200 and the folding sail 300, for holding the folding sail 300 in the folded state during travel of the satellite 100.

Preferably, the holding mechanism arranged between the non-folding sail 200 and the folding sail 300 can automatically release the fixation between the non-folding sail 200 and the folding sail 300 in response to a deorbit instruction, so as to allow the folding sail 300 to start to rotate about the first side of the non-folding sail 200.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

1. A deorbit-sail deployment device, comprising a non-folding sail (200) and a folding sail (300) that are rotatably connected to each other to form the deorbit sail for forming a deorbit sail that drives a satellite (100) to deorbit;
the device being characterized in:
the folding sail (300) including skeletons that fold a sail body in a folded state and support the sail body in an unfolded state, at least one of the skeletons is allowed to rotate about the non-folding sail (200) in a manner that it is fixed to the folding sail (300) when the folding sail (300) is partially free from the constraint of the non-folding sail (200), and the rest of the skeletons are allowed to rotate with respect to the non-folding sail (200) in a manner that the skeletons rotate about the folding sail (300).

2. The deployment device of claim 1, wherein the folding sail (300) comprises at least one first skeleton (300a) that folds the sail body in the folded state and supports the sail body in the unfolded state,
when a first included angle (α) formed between the folding sail (300) and the non-folding sail (200) in a process that the folding sail (300) rotating with respect to a first side of the non-folding sail (200) comes to a first threshold value, one or more of the first skeletons (300a) are allowed to rotate about the folding sail (300) in a manner that the first skeletons (300a) remain parallel to the first side, and the folding sail (300) continues to rotate with respect to the first side of the non-folding sail (200), so that the first included angle (α) continuously increases to a second threshold value that allows the folding sail (300) and the non-folding sail (200) to form the deorbit-sail.

3. The deployment device of claim 2, wherein the folding sail (300) includes at least one second skeleton (300b) that folds the sail body in the folded state and supports the sail body in the unfolded state, in which
at least one part of the second skeleton (300b) is folded into the first skeleton (300a) when receiving a contact force between the part and the non-folding sail (200) in a manner that the part is allowed to rotate about the first skeleton (300a), so that in the process that the folding sail (300) rotates with respect to the first side of the non-folding sail (200) the second skeleton (300b) is allowed to rotate about the first skeleton (300a) in a manner that a deployed area of the deorbit sail is allowed to increase.

4. The deployment device of claim 2, wherein during unfolding of the folding sail (300), the folding sail (300) rotates at a speed greater than or equal to a speed at which the first skeleton (300a) rotates.

5. The deployment device of claim 3, wherein during unfolding of the folding sail (300) the folding sail (300) rotates at a speed greater than or equal to a speed at which the second skeleton (300b) rotates.

6. The deployment device of claim 1, wherein the folding sail (300) includes a first skeleton II (300a-2) and at least two first skeletons I (300a-1) that are evenly distributed at two sides of the first skeleton II (300a-2),
in which the first skeleton II (300a-2) never rotates about the folding sail (300), and the at least two first skeletons I (300a-1) rotate about the folding sail (300) at a same speed when the first included angle (α) between the folding sail (300) and the non-folding sail (200) is greater than the first threshold value, so that the first skeleton II (300a-2) and the first skeletons I (300a-1) are allowed to form a support structure that supports the sail body during travel of the satellite (100) and during the unfolding of the folding sail (300).

7. The deployment device of claim 2, wherein the non-folding sail (200) has a first sail surface (200a) that is provided with a fastening hole (200b) configured to be engaged with a fastening member (300d) provided on the first skeleton (300a), in which
when the first included angle (α) formed between the folding sail (300) and the non-folding sail (200) in the process that the folding sail (300) rotates with respect to the first side of the non-folding sail (200) is smaller than the first threshold value, the fastening member (300d) and the fastening hole (200b) interact to prevent the first skeleton (300a) from rotating about the folding sail (300).

8. The deployment device of claim 7, wherein when the folding sail (300) is in the folded state, a second sail surface (300c) of the folded folding sail (300) in the folding state and the first sail surface (200a) are opposite to each other.

9. The deployment device of claim 8, wherein when the folding sail (300) is in the fully unfolded state, the second sail surface (300c) in the fully unfolded state and the first sail surface (200a) jointly form a windward surface or a leeward surface.

10. The deployment device of claim 6, wherein the folding sail (300) during unfolding has at least following intermediate attitudes of:
when the first included angle (α) is smaller than the first threshold value, a second included angle (β) formed between the first skeleton I (300a-1) and a second side of the non-folding sail (200) being 0°; or
when the first included angle (α) is greater than the first threshold value and smaller than the second threshold value, the second included angle (β) increases with the first included angle (α) in a manner that a maximum of the second included angle (β) being smaller than 90°; and
when the first included angle (α) is equal to the second threshold value, the second included angle (β) being equal to 90°.

11. The deployment device of claim 10, wherein in a process that the second included angle (β) increases with the first included angle (α), a free end of a said second skeleton II (300b-2) in the first skeleton II (300a-2) is allowed to rotate about the first skeleton II (300a-2) without coming into contact with the non-folding sail (200).

12. The deployment device of claim 1, wherein a holding mechanism is provided between the non-folding sail (200) and the folding sail (300), and serves to hold the folding sail (300) in the folded state during travel of the satellite (100).

13. The deployment device of claim 1, wherein the holding mechanism installed between the non-folding sail (200) and the folding sail (300) is configured to automatically release fixation between the non-folding sail (200) and the folding sail (300) in response to a deorbit instruction, so that the folding sail (300) is allowed to begin to rotate about the first side of the non-folding sail (200).

14. A folding sail (300) for the deployment of a deorbit sail, being configured to be unfolded in a process that it rotates about a non-folding sail (200) connected to a satellite (100) and to form the deorbit sail with the non-folding sail (200), the folding sail (300) being characterized in:
the folding sail (300) including skeletons that fold the sail body in a folded state and support the sail body in an unfolded state, at least one of the skeletons is allowed to rotate about the non-folding sail (200) in a manner that it is fixed to the folding sail (300) when the folding sail (300) is partially free from the constraint of the non-folding sail (200), and the rest of the skeletons are allowed to rotate with respect to the non-folding sail (200) in a manner that the skeletons rotate about the folding sail (300).

15. A deorbit sail, comprising a non-folding sail (200) and a folding sail (300) that are rotatably connected to each other to form the deorbit sail for driving a satellite (100) to deorbit; wherein
the folding sail (300) includes at least one first skeleton (300a) as well as at least one second skeleton (300b) that fold the sail body in a folded state and support the sail body in an unfolded state,
at least one part of the second skeleton (300b) is folded into the first skeleton (300a) when receiving a contact force between the part and the non-folding sail (200) in a manner that the part is allowed to rotate about the first skeleton (300a), so that in a process that the folding sail (300) rotates with respect to a first side of the non-folding sail (200) the second skeleton (300b) is allowed to rotate about the first skeleton (300a) in a manner that a deployed area of the deployed deorbit sail is allowed to increase.
